(19) United States
(12) Patent Application Publication
(10) Pub. No.: US 2020/0183622 A1
(43) Pub. Date: Jun. 11, 2020

(54) MEMORY CIRCUIT PACKAGE WITH ADJUSTABLE ACTIVE CHANNEL COUNT

(71) Applicant: Micron Technology, Inc., Boise, ID (US)

(72) Inventor: Daniel J. Hubbard, Boise, ID (US)

(21) Appl. No.: 16/213,720

(22) Filed: Dec. 7, 2018

(51) Int. Cl. G06F 3/06; G06F 12/02

(52) U.S. Cl. CPC G06F 3/0679; G06F 2212/7205; G06F 12/0246; G06F 3/0608

(57) ABSTRACT

Various embodiments described herein provide for a memory circuit package that comprises a plurality of memory die, a plurality of external memory channel interfaces, and a multiplexer circuit. The multiplexer circuit can selectively couple at least one memory die to either a first external memory interface (of the plurality of external memory channel interfaces) or a second external memory channel interface (of the plurality of external memory channel interfaces) based on a control input, thereby facilitating an adjustment in active memory channel count for the memory circuit package.

### TECHNICAL FIELD

Embodiments of the disclosure relate generally to memory and more specifically, to a memory circuit package with an adjustable count of active memory channels.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing environment including a memory sub-system, in accordance with some embodiments of the present disclosure.

FIG. 2 is a block diagram of an example memory circuit package with an adjustable count of active memory channels, in accordance with some implementations of the present disclosure.

FIGS. 3 and 4 are diagrams of example memory circuit packages with adjustable active memory channel counts, in accordance with some implementations of the present disclosure.

FIG. 5 is a flow diagram of an example method for adjusting an active memory channel count of a memory circuit package, in accordance with some implementations of the present disclosure.

FIG. 6 provides an interaction diagram illustrating interactions between components of a computing environment in the context of an example embodiment in which a method for adjusting an active memory channel count of a memory circuit package is performed.

FIG. 7 is a block diagram illustrating a diagrammatic representation of a machine in the form of a computer system within which a set of instructions can be executed for causing the machine to perform any one or more of the methodologies discussed herein, in accordance with some embodiments of the present disclosure.

### DETAILED DESCRIPTION

Aspects of the present disclosure are directed to a memory circuit package with an adjustable count of active memory channels, which may be used by or part of a memory sub-system. A memory sub-system is also hereinafter referred to as a “memory device.” An example of a memory sub-system is a storage system, such as a SSD. In some embodiments, the memory sub-system is a hybrid memory/storage sub-system. In general, a host system can utilize a memory sub-system that includes one or more memory components. The host system can provide data (e.g., via write requests) to be stored at the memory sub-system and can request data to be retrieved (e.g., via read requests) from the memory sub-system.

A memory sub-system can include multiple memory components that can store data from the host system. The memory sub-system can further include a memory sub-system controller that can communicate with each of the memory components to perform operations such as reading data, writing data, or erasing data at the memory components in response to requests received from the host system. Any one or more of the memory components of the memory sub-system may include a media controller to manage memory cells of the memory component, communicate with the memory sub-system controller, and execute memory requests (e.g., read or write) received from the memory sub-system controller.

Traditional memory circuit packages, such as Double Die Package (DDP)/Quad Die Package (QDP)/Eight Die Package (8DP)/Sixteen Die Package (16DP) negative-and (NAND)-type flash memory circuit packages (hereafter, NAND memory package), have been designed with a fixed number of active (operational) memory channels (e.g., 2 or 4 NAND memory channels). For instance, a traditional NAND memory package may comprise a fixed number of active NAND channels, such as one channel, two channels, or four channels. As a result, to meet demand for different memory channel configurations, memory manufacturers separately manufacture several different stock keeping units (SKUs) of memory circuit packages that combine different NAND memory package types (e.g., DDP, QDP, 8DP, 16DP) with different fixed memory channel configuration (e.g., one-channel, two-channel, four-channel). Each unique memory circuit package SKU can result in separate resources being used to manufacture the unique memory circuit package SKU (e.g., resources to generate/maintain separate memory circuit designs for the SKU, to perform separate qualifications on the SKU, to manage supply chain for the SKU, etc.). Additionally, with its fixed configuration of active memory channels, a traditional memory circuit package cannot provide flexibility in switching between different active memory channel modes, which can be useful in certain memory applications/solutions.

Various embodiments described herein provide for a memory circuit package, such as a NAND memory package, with an adjustable count of active memory channels (also referred to herein as adjustable active memory channel count), which can permit the memory circuit package to provide a flexible number of active and inactive memory channels (e.g., NAND memory channels). As used herein, a “memory circuit package” can comprise one or more memory die (e.g., NAND die) that are enclosed within the memory circuit package and accessible (e.g., for data read and data write) through one or more memory channels of the memory circuit package, which may be accessible through external memory channel interfaces. A memory circuit package can be implemented as a surface-mount integrated circuit (IC) package (e.g., circuit carrier) having an external pin layout (e.g., per industry standard) and capable of being mounted on a circuit substrate (e.g., printed circuit board (PCB)). Examples of circuit package types can include, without limitation, ball grid array (BGA) package, such as a low-profile ball grid array (LBGA) package. As used herein, a “memory die” can comprise a block of semiconducting material that implements a memory integrated circuit (IC). An example of a memory die can include, without limitation, a NAND memory die (hereafter, NAND die). Additionally, as user herein, an “external memory channel interface” can comprise one or more external pins, which facilitate data communication with a memory die of the memory circuit package over a memory channel of the memory circuit package.

Depending on the embodiment, the count of active memory channels provided by the memory circuit package can be controlled (e.g., dynamically controlled) through one or more external pins of the memory circuit package (e.g., disposed on the exterior surface of the memory circuit package) or through one or more commands transmitted to the memory circuit package via an external hardware interface (e.g., disposed on the exterior surface of the memory circuit package) for command or control of memory die of the memory circuit package. Depending on the embodiment, the switch between different active memory channel counts can be controlled by a controller of a memory sub-system where the memory sub-system comprises a memory circuit package described herein, or by a controller of a memory component where the memory component comprises the memory circuit package (the memory component may or may not be part of the memory sub-system).

Additionally, for some embodiments, the memory circuit package comprises one or more multiplexer circuits, the like, to control one or more electrical connections between one or more memory die (e.g., NAND die) of the memory circuit package and one or more external memory channel hardware interfaces of the memory circuit package (e.g., disposed on the exterior surface of the memory circuit package). These multiplexer circuits of the memory circuit package can be controlled by the external pins of the memory circuit package described above or by a controller that is controlled via the external hardware interface described above. For some embodiments, the memory die of the memory circuit package accessible via active memory channels prior to an adjustment in active memory channel count is the same memory die accessible via active memory channels after the adjustment in active memory channel count. Accordingly, the same memory die of the memory circuit package can be accessed regardless of the current count of active (operational) memory channels.

By use of various embodiments described herein, a memory circuit package (e.g., NAND memory package) can have the flexibility to switch between different active memory channel counts, such as between two-channels and four-channels or between one-channel and two-channels, while maintaining access to same memory die (e.g., NAND die) of the memory circuit package. Different configurations of active memory channel counts may be referred to as different memory channel modes, such as one-channel (1Ch) mode, two-channel (2Ch) mode, and four-channel (4Ch) mode. For instance, according to an embodiment, a QDP NAND memory package can be designed to operate in a two-channel or four-channel configuration (e.g., configuration is determined based on the setting of one or more external pins). Such a QDP NAND memory package could be produced based on a single circuit design, involve only single qualification process, and can be used in larger circuit design (e.g., printed circuit hoard (PCB)) specifically designed to use (e.g., take advantage of) the QDP NAND memory package's ability to be adjust between two-channel mode or four-channel mode. For some embodiments, the memory circuit package comprises one or more integrated input/output expanders (IOEs), which can be coupled to external memory channel interfaces by one or more multiplexer circuits to facilitate switching between different active memory channel counts/modes. For instance, according to an embodiment, a 16DP NAND memory package can comprises one or more IOEs configured such that the 16DP NAND memory package can switch between a one-channel mode and a two-channel mode. For some embodiments, an IOE of the memory circuit package can split up load to multiple memory die while re-driving the electric signal that pass through the 10E.

Compared to manufacturing traditional memory circuit packages, a memory manufacturer can provide memory circuit packages having different memory channel configurations with fewer memory circuit package SKUs by manufacturing memory circuit packages of various embodiments described herein. With fewer memory circuit package SKUs, the memory manufacturer can use less resources (e.g., a lower number of memory circuit designs that need to be generated/maintained, a lower number of separate qualifications that need to be performed, simpler supply chain management, etc.) in producing a variety of memory circuit packages with different memory channel configurations.

Additionally, a memory circuit package of some embodiments can enable, (or otherwise facilitate) reduction in power consumption by a system (e.g., a memory sub-system) that uses a memory circuit package described herein. In particular, for some embodiments, a memory sub-system comprises a memory circuit package described herein and when the memory sub-system enters a lower power or low-performance mode (e.g., from a normal or a high power/performance mode), a controller of the memory sub-system can adjust (or cause an adjustment of) the active (operational) memory channel count of the memory circuit package (e.g., from four active memory channels to two active memory channels), thereby causing the controller to use less memory channels than before (the adjustment) to access memory die of the memory circuit package. As noted herein, for some embodiments, the memory die of the memory circuit package accessible via active memory channels prior to the adjustment in the active memory channel count is the same memory die accessible via the active memory channels after the adjustment. With the reduction of memory channel count, the controller can disable one or more portions of the controller (e.g., power islands, such as memory channel portions, parity check engine portions, etc.) not presently used by the controller due to the reduction in active memory channels of the memory circuit package. The disablement of one or more of portions of the controller could cause the controller to use less power, which in turn can cause the memory sub-system that comprises the controller to use less power. Additionally, the reduction in the active memory channel count can cause the memory circuit package to use less power.

For example, in accordance with some embodiments, a memory sub-system (e.g., SSD) can comprise a controller supporting up to eight active memory channels, and two QDP NAND memory packages (that each can dynamically switch between two-channel mode and four-channel mode (e.g., via setting of one or more external pins). In normal/high.-performance mode, each of the two QDP NAND memory packages can be set to operate in four-channel mode, thereby resulting in all eight memory channels of the controller being connected to the two QDP NAND memory packages (thereby rendering all eight memory channels active). Alternatively, in low-performance mode, each of the two QDP NAND memory packages can be set to operate in two-channel mode, thereby resulting in only four memory channels of the controller being connected to the two QDP NAND memory packages (thereby rendering four memory channels active). According to various embodiments, whether the two QDP NAND memory packages are set to operate in two-channel mode or four-channel mode, all NAND die of the two QDP NAND memory packages remain accessible to the controller. As noted herein, the switch between two-channel mode and four-channel mode may be dynamically controlled (e.g., via the one or more external pins). With less than all eight memory channels being connected/used, the controller can disable portions (e.g., power islands, such as memory channel portions, parity check engine portions, etc.) of the controller associated with the unconnected/unused memory channels, thereby reducing power consumption by at least the controller.

Disclosed herein are some examples of systems that include or use a memory circuit package with an adjustable count of active memory channels, as described herein.

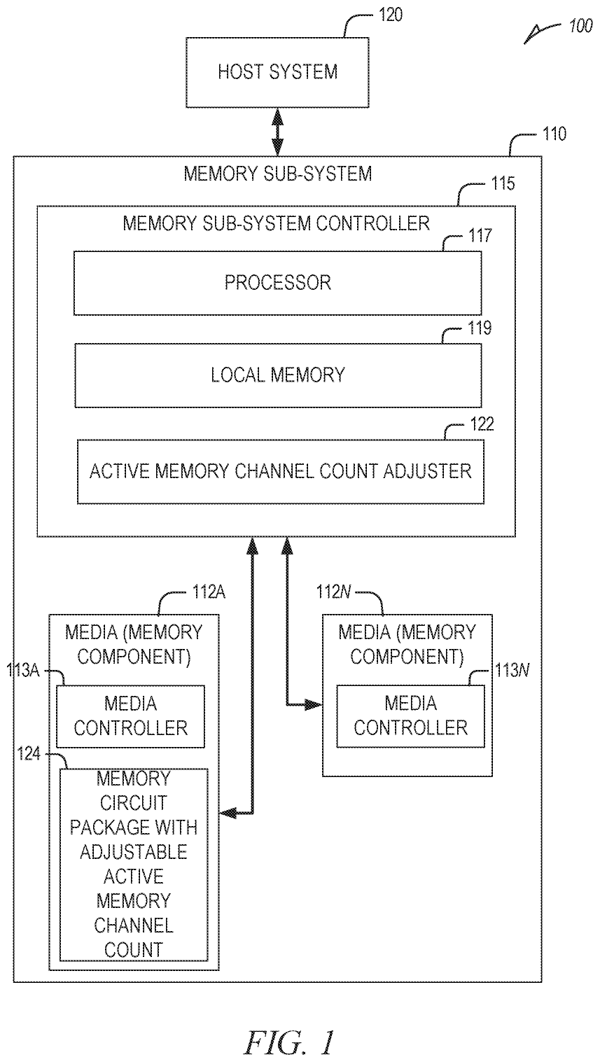

FIG. 1 illustrates an example computing environment 100, including a memory sub-system 110, in accordance with some examples of the present disclosure. The memory sub-system 110 can include media, such as memory components 112A to 112N. The memory components 112A to 112N can be volatile memory devices, non-volatile memory devices, or a combination of such. In some embodiments, the memory sub-system 110 is a storage system. An example of a storage system is an SSD. In some embodiments, the memory sub-system 110 is a hybrid memory/storage system. In general, the computing environment 100 can include a host system 120 that uses the memory sub-system 110. For example, the host system 120 can write data to the memory sub-system 110 and read data from the memory sub-system 110.

The host system 120 can be a computing device such as a desktop computer, laptop computer, network server, mobile device, or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. As used herein, “coupled to” generally refers to a connection between components, which can be an indirect communicative connection or a direct communicative connection (e.g., without intervening components), whether wired or wireless, including connections such as electrical, optical, magnetic, and so forth. Examples of a physical host interface include, but are not limited to, a serial advanced technology attachment (SATA) interface, a peripheral component interconnect express (PCIe) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe interface. The physical host interface can provide an interface for passing control, address, data, and other signals between the memory sub-system 110 and the host system 120.

The memory components 112A to 112N can include any combination of the different types of non-volatile memory components and/or volatile memory components. An example of non-volatile memory components includes a negative- and (NAND)-type flash memory. Each of the memory components 112A to 112N can include one or more arrays of memory cells such as single-level cells (SLCs) or multi-level cells (MLCs) (e.g., TLCs or QLCs). In some embodiments, a particular memory component 112 can include both an SLC portion and an MLC portion of memory cells. Each of the memory cells can store one or more bits of data (e.g., data blocks) used by the host system 120. A given set of memory cells of a memory component (e.g., 112A) can be provided by a memory circuit package (e.g., NAND memory package) described herein, such as a memory circuit package 124 with adjustable count of active memory channels (active memory channel count) of the memory component 112A. Although non-volatile memory components such as NAND-type flash memory are described, the memory components 112A to 112N can be based on any other type of memory, such as a volatile memory. In some embodiments, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), negative-or (NOR) flash memory, electrically erasable programmable read-only memory (EEPROM), and a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or data blocks that can refer to a unit of the memory component 112 used to store data.

The memory sub-system controller 115 can communicate with the memory components 112A to 112N to perform operations such as reading data, writing data, or erasing data at the memory components 112A to 112N and other such operations. The memory sub-system controller 115 can include hardware such as one or more integrated circuits and/or discrete components, a buffer memory, or a combination thereof. The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some embodiments, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another embodiment of the present disclosure, a memory sub-system 110 may not include a memory sub-system controller 115, and can instead rely upon external control (e.g., provided by an external host, or by a processor or controller separate from the memory sub-system 110).

In general, the memory sub-system controller 115 can receive commands or operations from the host system 120 and can convert the commands or operations into instructions or appropriate commands to achieve the desired access to the memory components 112A to 112N. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory components 112A to 112N. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory components 112A to 112N.

Any one of the memory components 112A to 112N can include a media controller (e.g., media controller 113A and media controller 11311) to manage the memory cells of the memory component 112, to communicate with the memory sub-system controller 115, and to execute memory requests (e.g., read or write) received from the memory sub-system controller 115.

The memory components 112A comprise the memory circuit package 124 with adjustable memory channel count, in accordance with various embodiments described herein. According to some embodiments, the memory circuit package 124 comprises a plurality of memory die, a plurality of external memory channel interfaces, and a multiplexer circuit. Depending on the embodiment, one or more of the memory die of the memory circuit package 124 comprises DDP, QDP, 8DP, or 16DP NAND memory die. Additionally, a given memory die can provide one or more memory cells (e.g., SLCs, TLCs, or QLCs) of the memory component 112A. For some embodiments, the plurality of memory die of the memory circuit package 124 comprises a first set of memory die and a second set of memory die. For some embodiments, the plurality of external memory channel interfaces of the memory circuit package 124 comprises a first external memory channel interface and a second external memory channel interface. According to some embodiments, the first external memory channel interface is coupled to the first set of memory die, and the multiplexer circuit is coupled to the second set of memory die and selectively couples the second set of memory die to one of the first external memory channel interface and the second external memory channel interface based on a control input. Accordingly, for some embodiments, where the multiplexer circuit couples the second set of memory die to the first external memory channel interface, both the first set of memory die and the second set of memory die are accessible via the first external memory channel interface over a single memory channel of the memory circuit package 124. On the other hand, for some embodiments, where the multiplexer circuit couples the second set of memory die to the second external memory channel interface, the first set of memory die is accessible via the first external memory channel interface over a first memory channel of the memory circuit package 124 and the second set of memory die is accessible via the second external memory channel interface over a second memory channel of the memory circuit package 124.

Within the memory circuit package 124, a given set of memory die can comprise two or more pluralities of memory die, where each plurality of memory die is coupled to an input/output expander (IOE) of memory circuit package 124, and an IOE is coupled to the multiplexer circuit of e memory circuit package 124. In this way, the IOE can couple the two or more pluralities of memory die to the multiplexer circuit. For instance, the first set of memory die can comprise a first plurality of memory die, a second plurality of memory die, and an IOE that couples the first external memory channel interface of the memory circuit package 124 to both the first plurality of memory die and the second plurality of memory die. Likewise, the second set of memory die can comprise a third plurality of memory die, a further plurality of memory die, and a second IOE that couples the multiplexer circuit to both the third plurality of memory die and the fourth plurality of memory die.

The control input to the multiplexer circuit can be provided by a set of external pins (e.g., disposed on the external surface of the memory circuit package 124), which can be driven by a controller (e.g., media controller 113A or the memory sub-system controller 115). For instance, the set of external pins can comprise a single pin and the control input can comprise a single bit that determines whether the second set of memory die is coupled to the first external memory channel interface or the second external memory channel interface. Depending on the embodiment, the multiplexer circuit of the memory circuit package 124 can comprise a plurality of multiplexers controlled based on the control input.

The memory sub-system controller 115 includes the active memory channel count adjuster 122 that enable the memory sub-system controller 115 to control the memory circuit package 124 to adjust its memory channel count as described herein (e.g., adjust between two active memory channels and four active memory channels). For example, the active memory channel count adjuster 122 can enable or cause the memory sub-system controller 115 to generate a control input for the multiplexer circuit of the memory circuit package 124, which the memory circuit package 124 can receive via one or more external pins (e.g., a single mode pin). Based on the active memory channel count adjuster 122, the memory sub-system controller 115 can generate the control input to cause the multiplexer circuit to couple the second set of memory die to the first external memory channel interface of the memory circuit package 124, or can generate the control input to cause the multiplexer circuit to couple the second set of memory die to the second external memory channel interface of the memory circuit package 124. The active memory channel count adjuster 122 can cause the memory sub-system controller 115 to generate the control input in response to, and based on, a request to adjust the active memory channel count of the memory circuit package 124. The request to adjust the active memory channel count of the memory circuit package 124 can be part of a larger request to adjust the active memory channel count of a plurality of memory circuit packages of the memory component 112A. Additionally, the memory sub-system controller 115 can cause generation of the control input to the memory circuit packages 124 via the media controller 113A of the memory component 112A. The request to adjust the active memory channel count can be associated with (e.g., generated in response to) a change in mode (e.g., power or performance mode) of the memory sub-system 110, which in turn may be based on a request received by the memory sub-system controller 115 (e.g., from the host system 120). For instance, in response to a request to change to a low power consumption mode (e.g., low-performance mode) of the memory sub-system 110, and the control input generated can cause the multiplexer circuit to couple the second set of memory die to the first external memory channel interface (thereby deactivating the memory channel associated with the second external memory channel interface). In another instance, in response to a request to change to a non-low power consumption mode (e.g., normal or high-performance mode) of the memory sub-system 110, and the control input generated can cause the multiplexer circuit to couple the second set of memory die to the second external memory channel interface (thereby activating the memory channel associated with the second external memory channel interface).

Depending on the embodiment, the active memory channel count adjuster 122 can comprise logic (e.g., a set of machine instructions, such as firmware) or one or more components that causes the memory sub-system 110 (e.g., the memory sub-system controller 115) to perform operations described herein with respect to the memory circuit package 124. The active memory channel count adjuster 122 can comprise a tangible unit capable of performing operations described herein. For alternative embodiments, the media controller 113A comprises some or all portions of the active memory channel count adjuster 122, and the media controller 113A operates to control the memory circuit package 124 as described with respect to the memory sub-system controller 115. Further details with regards to the operations of the memory circuit package 124 are described below.

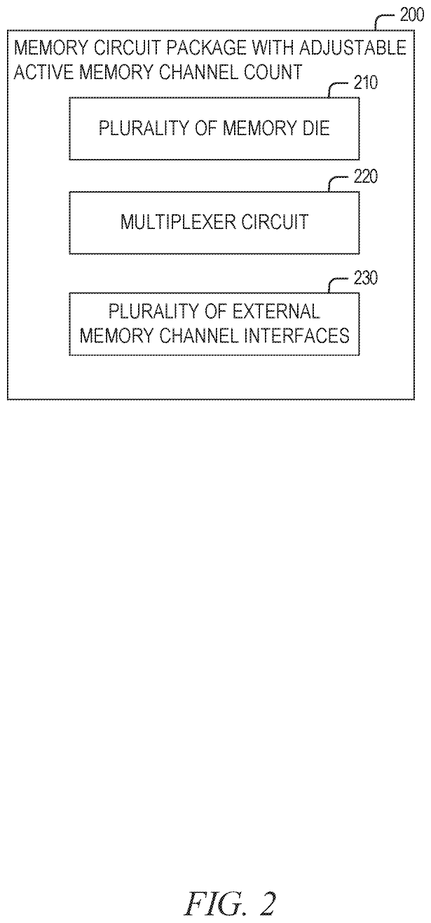

FIG. 2 is a block diagram of an example memory circuit package 200 with an adjustable count of active memory channels, in accordance with some implementations of the present disclosure. As shown, the memory circuit package 200 comprises a plurality of memory die 210, a multiplexer circuit 220, and a plurality of external memory channel interfaces 230. According to some embodiments, the plurality of memory die 210 comprises a first set of memory die and a second set of memory die, and the plurality of external memory channel interfaces 230 comprises a first external memory channel interface and a second external memory channel interface, where the first external memory channel interface is coupled to the first set of memory die. The multiplexer circuit 220 is coupled to the second set of memory die and selectively couples the second set of memory die to one of the first external memory channel interface and the second external memory channel interface based on a control input (e.g., received by the memory circuit package 200 via one or more external pins). A processing device operatively coupled to the memory circuit package 200 can receive a request to adjust an active memory channel count of the memory circuit package 200, and in response to the request, generate the control input based on the request. For instance, as described herein, the control input can be generated by a media controller (e.g., 113A) of a memory component 112 that includes the memory circuit package 200, or a controller (e.g., 115) of a memory sub-system 110 that includes the memory circuit package 200. Additionally, where a change in mode by the system (e.g., the memory sub-system 110) comprises a change to a low power consumption mode, the control input generated can cause the multiplexer circuit 220 to couple the second set of memory die to the first external memory channel interface (thereby deactivating the memory channel associated with the second external memory channel interface). Where a change in mode by the system (e.g., the memory sub-system 110) comprises a change to a non-low power consumption mode (e.g., normal or high-performance mode), the control input generated can cause the multiplexer circuit 220 to couple the second set of memory die to the second external memory channel interface (thereby activating the memory channel associated with the second external memory channel interface).

For some embodiments, the plurality of memory die 210 comprises one or more IOEs such that couple separate pluralities of memory die to a given external memory channel interface. For some embodiments, the plurality of memory die 210 comprises three or more separate sets of memory die, where each set of memory die 210 comprises at least one memory die 210. Further, for some embodiments, the plurality of external memory channel interfaces 230 comprises three or more external memory channel interfaces.

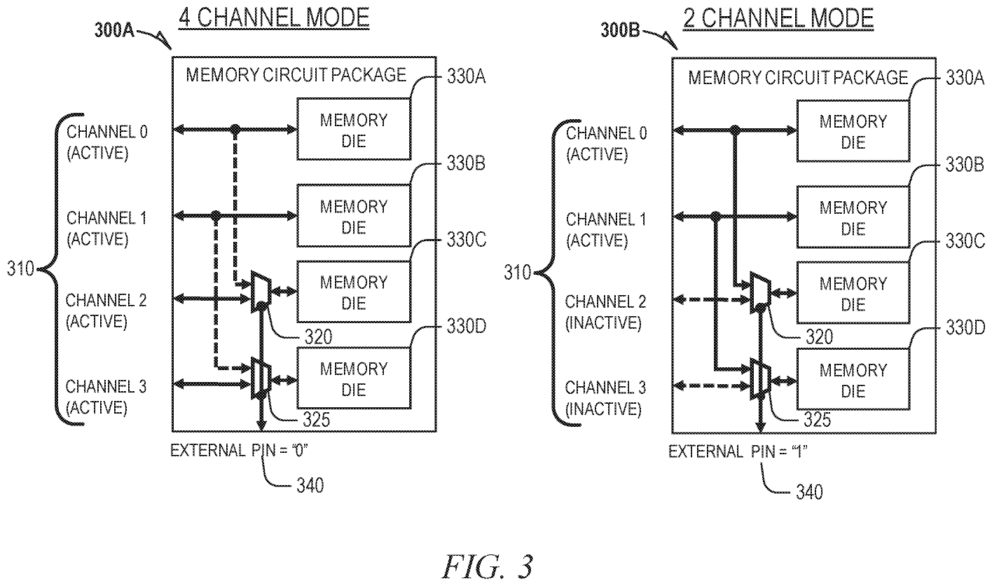

FIG. 3 is a diagram of an example memory circuit package 300 with adjustable memory channel count, in accordance with some implementations of the present disclosure. In particular, the memory circuit package 300 comprises a plurality of external memory channel interfaces 310, multiplexers 320, 325, an external pin 340 to provide a control input to the multiplexers 320, 325, and a plurality of memory die 330, which comprises memory die 330A, memory die 330B, memory die 330C, and memory die 330D. One or more of the memory die 330A, 330B, 330C, 330D can comprise NAND die, one or more of which can comprise NAND cells (e.g., SLC, TLC, or QLC).

The plurality of external memory channel interfaces 310 comprises memory channel 0, memory channel 1, memory channel 2, and memory channel 3, each of which can be rendered active or inactive based on the current memory channel count of the memory circuit package 300 as determined by the control input provided via the external pin 340. During operation of the memory circuit package 300, the control input can be used to dynamically adjust the active memory channel count (and therefore the memory channel configuration) of the memory circuit package 300. Depending on the embodiment, the external pin 340 can permit a media controller (e.g., 113A) or a memory sub-system controller (e.g., 115) to control the memory channel count of the memory circuit package 300. According to some embodiments, regardless of the current active memory channel count of the memory circuit packages 300, all of the memory die 330A, 330B, 3300, 330D are accessible (e.g., for data read or data write) via the current active memory channels.

300A refers to the memory circuit package 300 when all the external memory channel interfaces 310 (memory channel 0, memory channel 1 memory channel 3, and memory channel 3) are active, and 300B refers to the memory circuit package 300 when only two of the external memory channel interfaces 310—memory channel 0 and memory channel 1—are active.

As illustrated with respect to 300A, to operate in four-channel mode, the control input received by the memory circuit package 300 via the external pin 340 causes the multiplexer 320 to couple the memory die 330C to the external memory channel interface associated with memory channel 2, and causes the multiplexer 325 to couple the memory die 330D to the external memory channel interface associated with memory channel 3. The memory die 330A remains coupled to the external memory channel interface associated with memory channel 0, and the memory die 330B remains coupled to the external memory channel interface associated with memory channel 1.

As illustrated with respect to 300B, to operate in two-channel mode, the control input received by the memory circuit package 300 via the external pin 340 causes the multiplexer 320 to couple the memory die 330C to the external memory channel interface associated with memory channel 0 (shared with the memory die 330A), and causes the multiplexer 325 to couple the memory die 330D to the external memory channel interface associated with memory channel 1 (shared with the memory die 3309). The memory die 330A remains coupled to the external memory channel interface associated with memory channel 0, and the memory die 330B remains coupled to the external memory channel interface associated with memory channel 1.

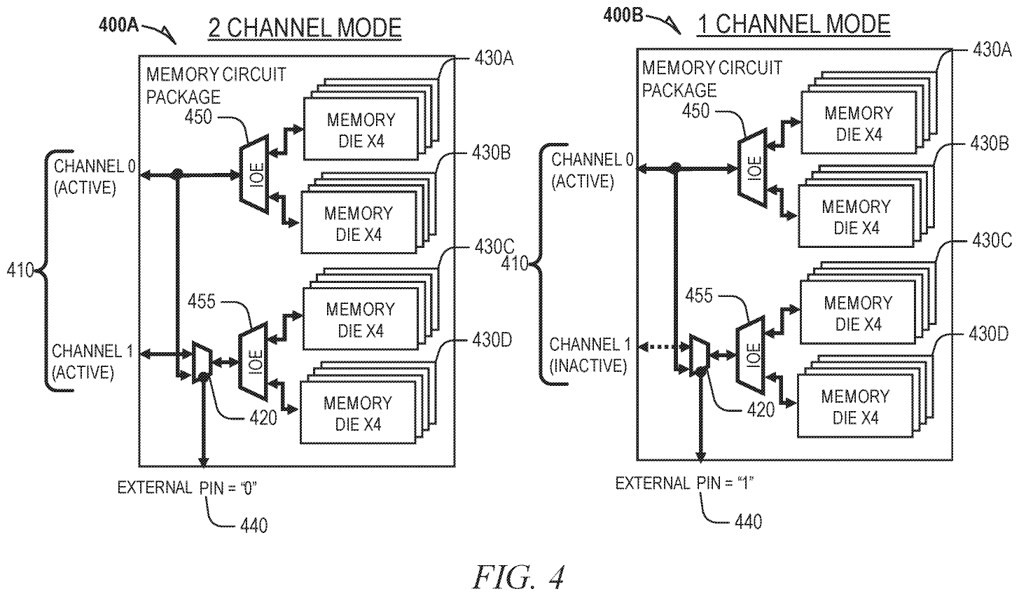

FIG. 4 is a diagram of an example memory circuit package 400 with adjustable memory channel count, in accordance with some implementations of the present disclosure. In particular, the memory circuit package 400 comprises a plurality of external memory channel interfaces 410, a multiplexer 420, an external pin 440 to provide a control input to the multiplexer 420, a plurality of input/output expanders (IOEs) 450, 455, and a plurality of memory die 430, which comprises a sub-plurality of memory die 430A, a sub-plurality of memory die 430B, a sub-plurality of memory die 430C, and a sub-plurality of memory die 430D. As illustrated, each of the sub-pluralities 430A, 430B, 430C, 430D comprises four die (e.g., Quad NAND Die), with each of the sub-pluralities 430A, 430B being coupled to the IOE 450 and each of the sub-pluralities 430C, 430D being coupled to the IOE 455.

Similar to the memory circuit package 300 of FIG. 3, the plurality of external memory channel interfaces 410 comprises memory channel 0 and memory channel 1, each of which can be rendered active or inactive based on the current memory channel count of the memory circuit package 400 as determined by the control input provided via the external pin 440. During operation of the memory circuit package 400, the control input can be used to dynamically adjust the active memory channel count (and therefore the memory channel configuration) of the memory circuit package 400. Depending on the embodiment, the external pin 440 can permit a media controller (e.g., 113A) or a memory sub-system controller (e.g., 115) to control the memory channel count of the memory circuit package 400. According to some embodiments, regardless of the current active memory channel count of the memory circuit packages 400, all of the sub-pluralities of memory die 430A, 430B, 430C, 430D are accessible (e.g., for data read or data write) via the current active memory channels.

As illustrated with respect to 400A, to operate in two-channel mode, the control input received by the memory circuit package 400 via the external pin 440 causes the multiplexer 420 to couple the IOE 455 (which is coupled to the sub-plurality of memory die 430C and the sub-plurality of memory die 430D) to the external memory channel interface associated with memory channel 1. The sub-plurality of memory die 430A and the sub-plurality of memory die 430B remain coupled to the external memory channel interface associated with memory channel 0 via the IOE 450.

As illustrated with respect to 400B, to operate in one-channel mode, the control input received by the memory circuit package 400 via the external pin 440 causes the multiplexer 420 to couple the IOE 455 (which is coupled to the sub-plurality of memory die 430C and the sub-plurality of memory die 430D) to the external memory channel interface associated with memory channel 0. The sub-plurality of memory die 430A and the sub-plurality of memory die 430B remain coupled to the external memory channel interface associated with memory channel 0 via the IOE 450.

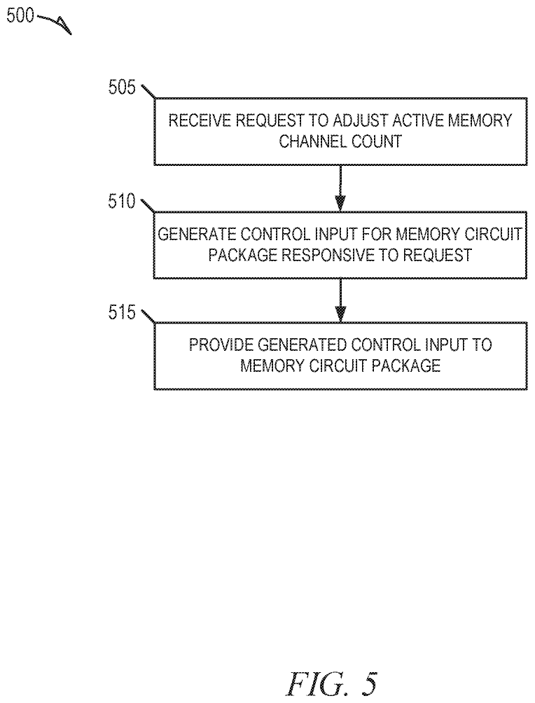

FIG. 5 is a flow diagram of an example method 500 for adjusting an active memory channel count of a memory circuit package, in accordance with some implementations of the present disclosure. The method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 500 is performed by the host system 120 of FIG. 1. In these embodiments, the method 500 can be performed, at least in part, by the active memory channel count adjuster 122. Alternatively, the method 500 is performed by the memory sub-system 110 of FIG. 1 (e.g., the processor of the memory sub-system controller 115). Although the processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring now to the method 500 of FIG. 5, at operation 505, a processing device of a memory sub-system (e.g., memory sub-system controller 115) or of a memory component (e.g., memory component 112A) receives a request to adjust an active memory channel count of the memory component (e.g., 112A). At operation 510, in response to the request, the processing device generates a control input for a memory circuit package (e.g., 124) based on the request.

As described herein, the memory circuit package can comprise: a plurality of memory die (e.g., 430) that comprises a first set of memory die and a second set of memory die; a plurality of external memory channel interfaces (e.g., 410) that comprises a first external memory channel interface and a second external memory channel interface, where the first external memory charm& interface is coupled to the first set of memory die; and a multiplexer circuit (e.g., 220) that is coupled to the second set of memory die and selectively couples the second set of memory die to one of the first external memory channel interface and the second external memory channel interface based on the control input. For some embodiments, where the request is to reduce the active memory channel count, generating the control input based on the request comprises generating the control input to cause the multiplexer circuit to couple the second set of memory die to the first external memory channel interface. In doing so, the memory circuit package deactivates the memory channel associated with a second external memory channel interface of the memory circuit package, thereby decreasing the memory channel count of the memory circuit package. Additionally, for some embodiments, where the request is to increase the active memory channel count, generating the control input based on the request comprises generating the control input to cause the multiplexer circuit to couple the second set of memory die to the second external memory channel interface. In doing so, the memory circuit package activates the memory channel associated with a second external memory channel interface of the memory circuit package, thereby increase the memory channel count of the memory circuit package. Eventually, at operation 515, the processing device provides (e.g., transmits) the control input (generated at operation 510) to the memory circuit package, which responds as described herein.

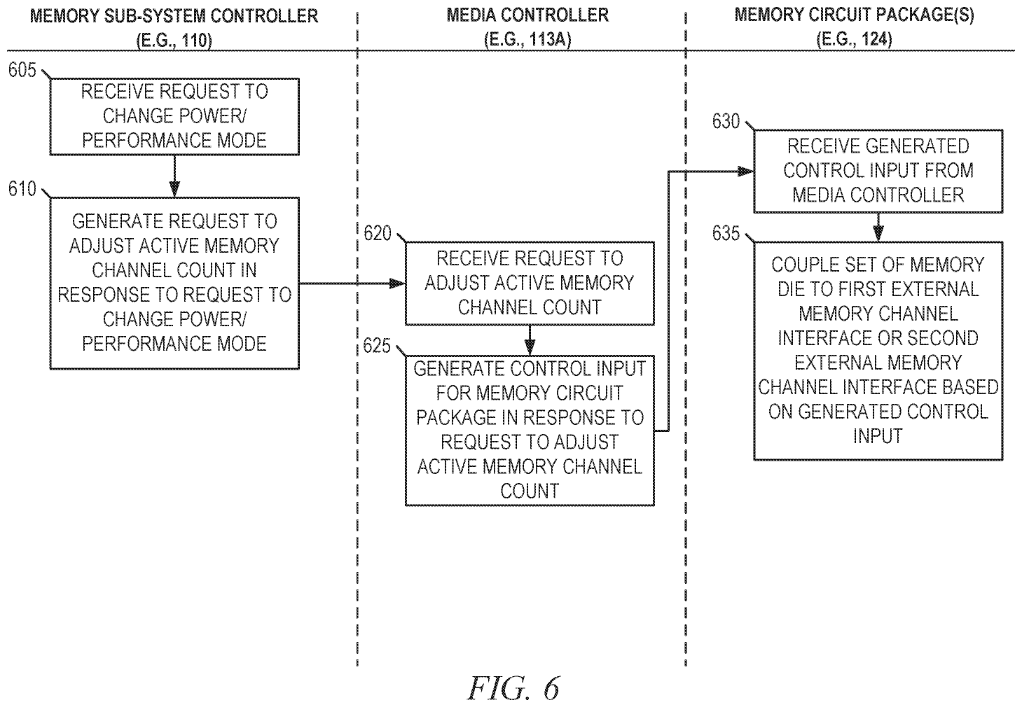

FIG. 6 provides an interaction diagram illustrating interactions between components of the computing environment 100 in the context of an example embodiment in which a method for adjusting an active memory channel count of a memory circuit package is performed. The operations of the method can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method is performed by a memory sub-system controller (e.g., 115), a media controller (e.g., 113A), or a combination of both. Although the operations are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment.

In the context of the example illustrated in FIG. 6, the memory sub-system controller can comprise the memory sub-system controller 115, the media controller can comprise the media controller 113A, and one or more memory circuit packages can comprise at least the memory circuit package 124 of the memory component 112A and can further comprise other memory circuit packages of the memory components 112A.

As shown in FIG. 6, at operation 605, the memory sub-system controller 115 receives (e.g., from the host system 120) a request to change a power or performance mode of the memory sub-system 110. In response, at operation 610, the memory sub-system controller 115 generates a request to adjust the count of active memory channel count for one or more memory components 112A to 112N of the memory sub-system 110. As described herein, in response to a request to change the memory sub-system 110 to a low power/performance mode, the request to adjust the count of active memory channels generated by the memory sub-system 110 can comprise a request to reduce the active memory channel count. On the other hand, in response to a request to change the memory sub-system 110 to a normal or high power/performance mode, the request to adjust the count of active memory channels generated by the memory sub-system 110 can comprise a request to increase the active memory channel count.

At operation 620, the media controller 113A of the memory component 112A receives the request to adjust the count of active memory channels from the memory sub-system controller 115. In response, at operation 625, media controller 113A generates a control input for at least the memory circuit package 124 (if not for other similar memory circuit packages of the memory component 112A) based on the request to adjust the count of active memory channels. As described herein, the request to adjust the count of active memory channels can comprise a request to increase or decrease the active memory channel count of the memory circuit package 124.

At operation 630, the memory circuit package 124 receives the control input generated by the media controller 113A. Based on the generated control input, the memory circuit package 124 adjusts its count of active memory channels. In particular, at operation 635, based on the generated control input, a multiplexer circuit of the memory circuit package 124 couples a (second) set of memory die of the memory circuit package 124 to a first external memory channel interface or a second external memory channel interface. For some embodiments, a first set of memory die of the memory circuit package 124 is coupled to the first external memory channel interface and, based on the generated control input, a second set of memory die of the memory circuit package 124 is coupled to the first external memory channel interface or the second external memory channel interface. Accordingly, at operation 635, the second set of memory die is coupled to the first external memory channel interface to reduce the count of active memory channels of the memory circuit package 124 based on the generated control input, and the second set of memory die is coupled to the second external memory channel interface to increase the count of active memory channels of the memory circuit package 124 based on the generated control input.

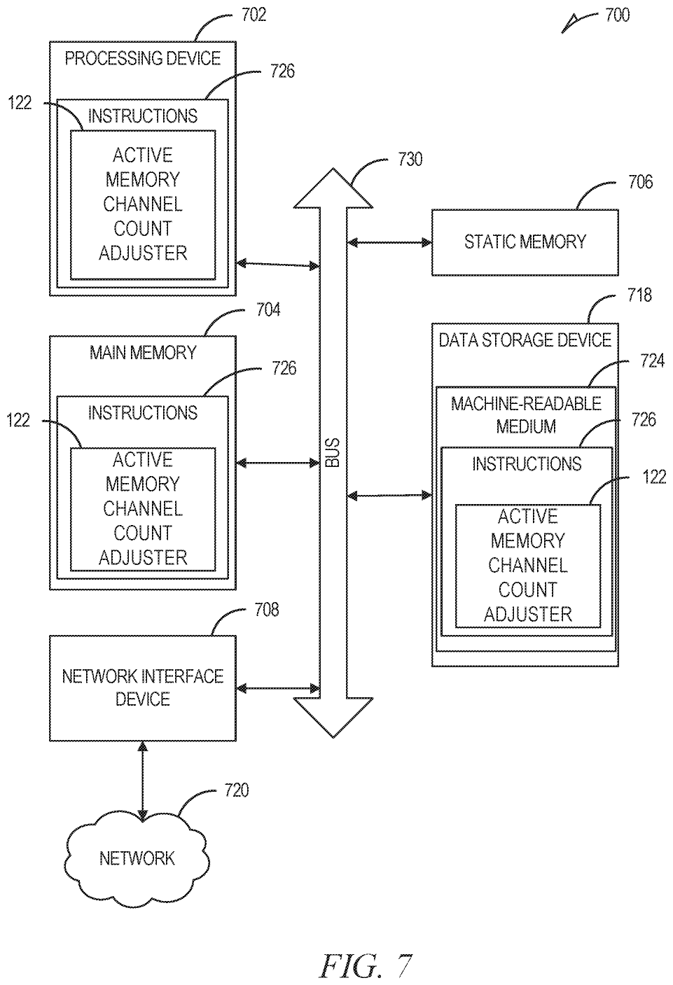

FIG. 7 illustrates an example machine in the form of a computer system 700 within which a set of instructions can be executed for causing the machine to perform any one or more of the methodologies discussed herein. In some embodiments, the computer system 700 can correspond to a host system (e.g., the host system 120 of FIG. 1) that includes, is coupled to, or utilizes a memory sub-system (e.g., the memory sub-system 110 of FIG, 1) or can be used to perform the operations of a controller (e.g., to execute an operating system to perform operations corresponding to the active memory channel count adjuster 122 of FIG. 1). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730.

The processing device 702 represents one or more general-purpose processing devices such as a microprocessor, a central processing unit, or the like. More particularly, the processing device 702 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 702 can also be one or more special-purpose processing devices such as an application specific integrated circuit (ASIC), a field programmable gate array (FPGA), a digital signal processor (DSP), a network processor, or the like. The processing device 702 is configured to execute instructions 726 for performing the operations and steps discussed herein. The computer system 700 can further include a network interface device 708 to communicate over a network 720.

The data storage device 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage device 718, and/or main memory 704 can correspond to the memory sub-system 110 of FIG. 1.

In one embodiment, the instructions 726 include instructions to implement functionality corresponding to an adjustment in active memory channel count of a memory circuit package as described herein (e.g., the active memory channel count adjuster 122 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system' s memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROMs); random access memories (RAMS); erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, embodiments of the disclosure have been described with reference to specific example embodiments thereof. It will be evident that various modifications can he made thereto without departing from embodiments of the disclosure as set forth in the following claims. The specification and drawings are, accordingly, to be regarded in an illustrative sense rather than a restrictive sense.

### EXAMPLES

Example 1 is a system comprising: memory component comprising a memory circuit package, the memory circuit package comprising: a plurality of memory die that comprises a first set of memory die and a second set of memory die; a plurality of external memory channel interfaces that comprises a first external memory channel interface and a second external memory channel interface, the first external memory channel interface being coupled to the first set of memory die; and a multiplexer circuit coupled to the second set of memory die and selectively coupling the second set of memory die to one of the first external memory channel interface and the second external memory channel interface based on a control input; and a processing device, operatively coupled to the memory component, configured to perform operations comprising: receiving a request to adjust an active memory channel count of the memory component; and in response to the request, generating the control input based on the request.

In Example 2, the subject matter of Example 1 optionally includes where the plurality of memory die further comprises a third set of memory die and a fourth set of memory die, where the plurality of external memory channel interfaces further comprises a third external memory channel interface and a fourth external memory channel interface, where the third external memory channel interface is coupled to the third set of memory die, and where the multiplexer circuit is further coupled to the fourth set of memory die and selectively couples the fourth set of memory die to one of the third external memory channel interface and the fourth external memory channel interface based on the control input.

In Example 3, the subject matter of Example 1 or Example 2 optionally includes where the multiplexer circuit comprises a plurality of multiplexers controlled based on the control input.

In Example 4, the subject matter of any one of Examples 1 to 3 optionally includes where the generating the control input based on the request comprising generating the control input to cause the multiplexer circuit to couple the second set of memory die to the first external memory channel interface.

In Example 5, the subject matter of any one of Examples 1 to 4 optionally includes where the generating the control input based on the request comprising generating the control input to cause the multiplexer circuit to couple the second set of memory die to the second external memory channel interface.

In Example 6, the subject matter of any one of Examples 1 to 5 optionally includes where the first set of memory die comprises: a first plurality of memory die; a second plurality of memory die; and an input/output expander coupling the first external memory channel interface to both the first plurality of memory die and the second plurality of memory die.

In Example 7, the subject matter of any one of Examples 1 to 6 optionally includes where the second set of memory die comprises: a third plurality of memory die; a fourth plurality of memory die; and a second input/output expander coupling the multiplexer circuit to both the third plurality of memory die and the fourth plurality of memory die

In Example 8, the subject matter of any one of Examples 1 to 7 optionally includes where the request is associated with a change in mode by the system.

In Example 9, the subject matter of any one of Examples 1 to 8 optionally includes where the change in mode comprises a change to a low power consumption mode by the system, and where generating the control input based on the request comprising generating the control input to cause the multiplexer circuit to couple the second set of memory die to the first external memory channel interface.

In Example 10, the subject matter of any one of Examples 1 to 9 optionally includes where the change in mode comprises a change to a non-low power consumption mode by the system, and where generating the control input based on the request comprising generating the control input to cause the multiplexer circuit to couple the second set of memory die to the second external memory channel interface.

Example 11 is a method comprising: a plurality of memory die that comprises a first set of memory die and a second set of memory die; a plurality of external memory channel interfaces that comprises a first external memory channel interface and a second external memory channel interface, the first external memory channel interface being coupled to the first set of memory die; and a multiplexer circuit coupled to the second set of memory die and selectively coupling the second set of memory die to one of the first external memory channel interface and the second external memory channel interface based on a control input.

In Example 12, the subject matter of Example 11 optionally includes where the plurality of memory die further comprises a third set of memory die and a fourth set of memory die, where the plurality of external memory channel interfaces further comprises a third external memory channel interface and a fourth external memory channel interface, where the third external memory channel interface is coupled to the third set of memory die, and where the multiplexer circuit is further coupled to the fourth set of memory die and selectively couples the fourth set of memory die to one of the third external memory channel interface and the fourth external memory channel interface based on the control input.

In Example 13, the subject matter of Example 11 or Example 12 optionally includes where the multiplexer circuit comprises a plurality of multiplexers controlled based on the control input.

In Example 14, the subject matter of any one of Examples 11 to 13 optionally includes where the first set of memory die comprises: a first plurality of memory die; a second plurality of memory die; and an input/output expander coupling the first external memory channel interface to both the first plurality of memory die and the second plurality of memory die.

In Example 15, the subject matter of any one of Examples 11 to 14 optionally includes where the second set of memory die comprises: a third plurality of memory die; a fourth plurality of memory die; and a second input/output expander coupling the multiplexer circuit to both the third plurality of memory die and the fourth plurality of memory die.

Example 16 is a method comprising: receiving a request to adjust an active memory channel count of the memory component; in response to the request, generating a control input based on the request; and providing the generated control input to a memory circuit package, the memory circuit package comprises: a plurality of memory die that comprises a first set of memory die and a second set of memory die; a plurality of external memory channel interfaces that comprises a first external memory channel interface and a second external memory channel interface, the first external memory channel interface being coupled to the first set of memory die; and a multiplexer circuit coupled to the second set of memory die and selectively coupling the second set of memory die to one of the first external memory channel interface and the second external memory channel interface based on the control input.

In Example 17, the subject matter of Example 16 optionally includes generating the control input based on the request comprising generating the control input to cause the multiplexer circuit to couple the second set of memory die to the first external memory channel interface.

In Example 18, the subject matter of Example 16 or Example 17 optionally includes generating the control input based on the request comprising generating the control input to cause the multiplexer circuit to couple the second set of memory die to the second external memory channel interface.

In Example 19, the subject matter of any one of Examples 16 to 18 optionally includes where the request is associated with a change in mode by the system, where the change in mode comprises a change to a low power consumption mode by the system, and where generating the control input based on the request comprising generating the control input to cause the multiplexer circuit to couple the second set of memory die to the first external memory channel interface.

In Example 20, the subject matter of any one of Examples 16 to 19 optionally includes where the request is associated with a change in mode by the system, where the change in mode comprises a change to a non-low power consumption mode by the system, and where generating the control input based on the request comprising generating the control input to cause the multiplexer circuit to couple the second set of memory die to the second external memory channel interface.

What is claimed is:

1. A system comprising:
a memory component comprising a memory circuit package, the memory circuit package comprising:
a plurality of memory die that comprises a first set of memory die and a second set of memory die;
a plurality of external memory channel interfaces that comprises a first external memory channel interface and a second external memory channel interface, the first external memory channel interface being coupled to the first set of memory die; and
a multiplexer circuit coupled to the second set of memory die and selectively coupling the second set of memory die to one of the first external memory channel interface and the second external memory channel interface based on a control input; and
a processing device, operatively coupled to the memory component, configured to perform operations comprising:
receiving a request to adjust an active memory channel count of the memory component; and
in response to the request, generating the control input based on the request.

2. The system of claim 1, wherein the plurality of memory die further comprises a third set of memory die and a fourth set of memory die, wherein the plurality of external memory channel interfaces further comprises a third external memory channel interface and a fourth external memory channel interface, wherein the third external memory channel interface is coupled to the third set of memory die, and wherein the multiplexer circuit is further coupled to the fourth set of memory die and selectively couples the fourth set of memory die to one of the third external memory channel interface and the fourth external memory channel interface based on the control input.

3. The system of claim 2, wherein the multiplexer circuit comprises a plurality of multiplexers controlled based on the control input.

4. The system of claim 1, wherein the generating the control input based on the request comprises generating the control input to cause the multiplexer circuit to couple the second set of memory die to the first external memory channel interface.

5. The system of claim 1, wherein the generating the control input based on the request comprises generating the control input to cause the multiplexer circuit to couple the second set of memory die to the second external memory channel interface.

6. The system of claim 1, where the first set of memory die comprises:
a first plurality of memory die;
a second plurality of memory die; and
an input/output expander coupling the first external memory channel interface to both the first plurality of memory die and the second plurality of memory die.

7. The system of claim 6, where the second set of memory die comprises:
a third plurality of memory die;
a fourth plurality of memory die; and
a second input/output expander coupling the multiplexer circuit to both the third plurality of memory die and the fourth plurality of memory die.

8. The system of claim 1, wherein the request is associated with a change in mode by the system.

9. The system of claim 8, wherein the change in mode comprises a change to a low power consumption mode by the system, and wherein generating the control input based on the request comprises generating the control input to cause the multiplexer circuit to couple the second set of memory die to the first external memory channel interface.

10. The system of claim 8, wherein the change in mode comprises a change to a non-low power consumption mode by the system, and wherein the generating the control input based on the request comprises generating the control input to cause the multiplexer circuit to couple the second set of memory die to the second external memory channel interface.

11. A memory circuit package comprising:
a plurality of memory die that comprises a first set of memory die and a second set of memory die;
a plurality of external memory channel interfaces that comprises a first external memory channel interface and a second external memory channel interface, the first external memory channel interface being coupled to the first set of memory die; and
a multiplexer circuit coupled to the second set of memory die and selectively coupling the second set of memory die to one of the first external memory channel interface and the second external memory channel interface, based on a control input.

12. The memory circuit package of claim 11, wherein the plurality of memory die further comprises a third set of memory die and a fourth set of memory die, wherein the plurality of external memory channel interfaces further comprises a third external memory channel interface and a fourth external memory channel interface, wherein the third external memory channel interface is coupled to the third set of memory die, and wherein the multiplexer circuit is further coupled to the fourth set of memory die and selectively couples the fourth set of memory die to one of the third external memory channel interface and the fourth external memory channel interface, based on the control input.

13. The memory circuit package of claim 12, wherein the multiplexer circuit comprises a plurality of multiplexers controlled based on the control input.

14. The memory circuit package of claim 11, where the first set of memory die comprises:
a first plurality of memory (lie;
a second plurality of memory die; and
an input/output expander coupling the first external memory channel interface to both the first plurality of memory die and the second plurality of memory die.

15. The memory circuit package of claim 14, where the second set of memory die comprises:
a third plurality of memory die;
a fourth plurality of memory die; and
a second input/output expander coupling the multiplexer circuit to both the third plurality of memory die and the fourth plurality of memory die.

16. A method comprising:
receiving a request to adjust an active memory channel count of the memory component;
in response to the request, generating a control input based on the request; and
providing the generated control input to a memory circuit package, the memory circuit package comprising:
a plurality of memory die that comprises a first set f memory die and a second set of memory die;
a plurality of external memory channel interfaces that comprises a first external memory channel interface and a second external memory channel interface, the first external memory channel interface being coupled to the first set of memory die; and
a multiplexer circuit coupled to the second set of memory die and selectively coupling the second set of memory die to one of the first external memory channel interface and the second external memory channel interface, based on the control input.

17. The method of claim 16, wherein the generating the control input based on the request comprises generating the control input to cause the multiplexer circuit to couple the second set of memory die to the first external memory channel interface.

18. The method of claim 16, wherein the generating the control input based on the request comprising generating the control input to cause the multiplexer circuit to couple the second set of memory die to second external memory channel interface.

19. The method of claim 16, wherein the request is associated with a change in mode by the system, wherein the change in mode comprises a change to a low power consumption mode by the system, and wherein generating the control input based on the request comprises generating the control input to cause the multiplexer circuit to couple the second set of memory die to the first external memory channel interface.

20. The method of claim 16, wherein the request is associated with a change in mode by the system, wherein the change in mode comprises a change to a non-low power consumption mode by the system, and wherein the generating the control input based on the request comprises generating the control input to cause the multiplexer circuit to couple the second set of memory die to the second external memory channel interface.
